(19) United States
(12) Patent Application Publication
(10) Pub. No.: US 2014/0328662 A1
(43) Pub. Date: Nov. 6, 2014

(54) MANHOLE DEBRIS SHIELD

(71) Applicant: Lyman H. Whitney, Rindge, NH (US)

(72) Inventor: Lyman H. Whitney, Rindge, NH (US)

(21) Appl. No.: 14/171,826

(22) Filed: Feb. 4, 2014

Related U.S. Application Data
(60) Provisional application No. 61/817,920, filed on May 1, 2013.

(51) Int. Cl. B66C 1/16

(52) U.S. Cl. CPC B66C 1/16
USPC 414/800; 294/74

(57) ABSTRACT

A device for capturing and removing substantially all debris that falls into a manhole includes a flexible, substantially circular folded disk that is inserted into the manhole prior to performance of the debris-creating work, and is unfolded by an unfolding mechanism until the rim of the disk rests against the manhole bounding wall. Semi-rigid rods are secured to eyelets adjacent to the perimeter of the disk and terminate above the disk at a common junction, to which a removal and insertion mechanism can be attached. The device may be left inside of the manhole, separated from the insertion and removal mechanism, during performance of the debris creating work, and then folded and removed after the work is completed, thereby trapping and removing the debris. In embodiments, the unfolding mechanism includes supports radiating outward from the center of the disk and attached to the disk along their entire lengths.

### RELATED APPLICATIONS

This application claims the benefit of U.S. Provisional Application No. 61/817,920, filed May 1, 2013, which is herein incorporated by reference in its entirety for all purposes.

### FIELD OF THE INVENTION

The invention relates to an apparatus useful primarily in the construction industry, and more particularly, to an apparatus for catching and removing fallen debris from manholes.

### BACKGROUND OF THE INVENTION

Manholes are encountered in the construction industry, and particularly the roadway construction industry. Frequently, the frames and covers associated with these manholes need to be removed and subsequently replaced for one or more of the following reasons:

A. Replace the broken frame and/or cover
B. Adjust the level of the cover upwards so that it is equal in elevation to roadway or sidewalk resurfacing
C. Install new manholes

During the steps involved in removing the manhole frame and cover from the top of the manhole, the pavement adjacent to the frame is removed using a jack-hammer or other tool. The underlying gravel is then removed from the top of the manhole. Next, the frame, cover, and underlying brick mortar on which the frame is set, are loosened, usually by tapping with a sledge hammer, and then removed by hand.

Replacement of the frame and cover, new or existing, starts by applying mortar and brick, usually two courses or more, until the desired elevation is established. The desired elevation is typically when the frame and cover are level with the surface of the road or sidewalk.

During the steps of removing and replacing the manhole frame and cover, it is typical for paving materials, gravel, mortar, bricks, and other debris to fall into the manhole. This debris must be retrieved before the task is complete.

One existing method of retrieving debris from manholes involves the use of manual labor, whereby one or more workers descend into the hole and retrieve the debris by hand. This method does not address the problem of debris travelling downstream from the manhole through active pipes. In roadway construction, this problem becomes particularly acute when dealing with sewers, which typically employ one or more open conduits located at the bottom of the manhole.

A worker descending into a manhole must take adequate safety precautions to mitigate the inherent risks of climbing into such holes. Typically the worker will be outfitted in a harness, and secured to a tripod structure that is positioned over the hole. The worker will then be lowered into the hole using a rope or cable suspended from the tripod. Before lowering workers into manholes, gas measuring devices are commonly employed to ensure that the air inside the manholes is not toxic. Violations of applicable safety regulations can result in fines administered by the Occupational Safety and Health Administration (OSHA), and can also lead to injury or death.

Another existing method of retrieving debris from manholes is by using a so-called “jet-vac.” Jet-vacs are combination high pressure water sprayers and high volume vacuums. They are able to remove debris from the bottom of a manhole, as well as debris that has traveled downstream through open conduits. A jet-vac may be built into a vehicle specially designed for this purpose, or towed behind a general purpose vehicle such as a trailer. Jet-vacs are effective, but expensive, ranging from approximately $200,000 to $400,000 in cost.

What is needed, therefore, is a simple, safe, and effective way to capture and remove substantially all debris that falls into a manhole, without allowing any of the debris to enter any open conduits that may be located in the manhole.

### SUMMARY OF THE INVENTION

The present invention is a debris capturing and removal device and method that provide a simple, safe, and effective solution for capturing and removing substantially all debris that falls into a manhole, while simultaneously preventing the debris from entering any open conduits that may be located in the manhole. The device comprises a flexible disk having at least four evenly spaced eyelets adjacent to its perimeter. The disk can be suspended from a plurality of substantially rigid rods having distal ends and proximal ends. In embodiments, the rods are equal in number with the eyelets, and are configured so that a distal end of a rod is secured to each eyelet. The proximal ends of the rods meet at a common junction above the disk, where they are able to independently pivot about the common junction.

An attachment mechanism fixed to the common junction can be used to attach a hoisting mechanism to the rods for lifting and lowering the apparatus. When the apparatus is suspended from the attachment mechanism, the rods tend to pivot downwardly and hang vertically due to the weight of the suspended disk, causing the eyelets to be drawn together, so that the disk folds and forms a bag or sack. However, when the apparatus is resting at the bottom of a manhole and released from the hoisting mechanism, an unfolding mechanism included in the apparatus unfolds the disk until it becomes flat, or until its circumference rests against the bounding wall of the manhole.

In some embodiments, the unfolding mechanism includes a plurality of substantially rigid supports radiating outwards from the center of the disk, each of the supports being secured to the disk over substantially its entire length. In some of these embodiments the supports are equal in number with the eyelets and are configured so that a distal end of a support is proximal to each eyelet. When the apparatus is resting at the bottom of a manhole, the distal ends of the supports naturally fall outward while the proximal ends remain near the center of the disk, thereby opening the disk until it is flat, or until its perimeter is resting against the bounding wall of the manhole.

If there is an open conduit or other depression in the floor of the manhole, and if the flexible disk were simply unfolded across the open conduit, there could be a tendency for falling debris striking near the center of the disk to damage or tear the disk fabric. In embodiments, this is avoided by including a support structure that supports the center of the disk when it is resting over an open conduit. In embodiments, the support structure includes a flat plate that is removably attached to the bottom center of the disk, for example by inserting a bolt through the plate and through a central eyelet in the disk. Some of these embodiments further include a peg extending downward from the plate and configured to rest at the bottom of the open conduit. In other embodiments, the flat plate is configured to span the open conduit so that it rests on either side of the open conduit and is supported substantially at the level of the surrounding floor.

It will be understood that the present invention is not limited to only the expansion mechanism examples presented herein, but includes any expansion mechanism that will allow the disk to collapse while the apparatus is suspended from the rods, while causing the rim of the disk to expand when the apparatus is not suspended until the disk is flat, or until the rim of the disk is resting against the bounding wall of the manhole. Similarly, the present invention is not limited to only the support mechanism examples presented herein, but includes any support mechanism that supports the center of the flexible disk when positioned above an open conduit or other depression in the floor of the manhole.

One general aspect of the present invention is a debris removal device for capturing and removing falling debris. The device includes a flexible disk, a plurality of eyelets adjacent to the perimeter of the flexible disk, an unfolding mechanism, configured when the weight of the device is supported by a surface to unfold the disk until the disk is flat, or until the perimeter of the disk is resting against a surrounding wall, a plurality of substantially rigid rods having distal ends and proximal ends, the substantially rigid rods being equal in number with the eyelets, and being configured so that a distal end of a rod is pivotally secured to each eyelet, a common junction above the disk, at which the proximal ends of the rods pivotally terminate, and an attachment mechanism fixed to the common junction, the attachment mechanism being configured for attachment thereto of a hoisting mechanism.

In embodiments, the unfolding mechanism includes a plurality of substantially rigid supports radiating outwards from the center of the disk, each of the supports being secured to the disk over substantially its entire length. In some of these embodiments, the supports are equal in number with the eyelets and are configured so that a distal end of a rigid support is proximal to each eyelet. In other of these embodiments the supports are secured to the disk by stitching. In still other of these embodiments, the supports are semi-rigid metal straps. In yet other of these embodiments the supports are HDPE straps. And in some of these embodiments the HDPE straps are approximately 1′6″ in length, approximately 1″ in width, and approximately ¼″ thick.

In various embodiments the rods are approximately 3/16″ in diameter and approximately 2′9″ in length. In certain embodiments, the disk is permeable to water. In some embodiments, the disk is constructed of a fabric material. In other embodiments the disk is approximately four feet in diameter.

In embodiments, each eyelet is reinforced by a metal grommet surrounding its perimeter. In some embodiments, the a hoisting mechanism, wherein the hoisting mechanism is a telescoping pole with a hook at its distal end of sufficient size to connect with the attachment mechanism.

Certain embodiments further include a plate fixed to the bottom center of the flexible disk, and a downwardly extending peg secured to a bottom of the plate, the peg being configured to rest at a bottom of an open conduit so as to position the plate substantially even with a top of the open conduit.

Various embodiments further include a plate fixed to the bottom center of the flexible disk, the plate being configured to span an open conduit so as to position the plate substantially even with a top of the open conduit. In some of these embodiments, the plate is removably attached to the disk.

Another general aspect of the present invention is a method for capturing and removing debris from a manhole after performing debris-creating work above the manhole. The method includes providing a debris removal device including a flexible disk, a plurality of eyelets adjacent to the perimeter of the flexible disk, an unfolding mechanism configured to unfold the disk when the weight of the device is supported by a surface until the disk is flat, or until the perimeter of the disk is resting against a surrounding wall, a plurality of substantially rigid rods having distal ends and proximal ends, the substantially rigid rods being equal in number with the eyelets, and being configured so that a distal end of a rod is pivotally secured to each eyelet, a common junction above the disk, at which the proximal ends of the rods pivotally terminate, and an attachment mechanism fixed to the common junction, the attachment mechanism being configured for attachment thereto of a hoisting mechanism.

The method further includes attaching a hoisting mechanism to the attachment mechanism, lowering the debris removal device into the manhole, until the center of the disk rests on the bottom of the manhole, and the unfolding mechanism unfolds the disk until the disk is flat or substantially all of its perimeter makes contact with the boundary wall of the manhole, while the semi-rigid rods extend upward above the disk to the common junction detaching the hoisting device from the attachment mechanism and removing the hoisting device from the manhole performing the debris-creating work, whereby any debris that enters the manhole falls onto the disk, reattaching the hoisting mechanism to the attachment mechanism, and hoisting the debris removal device out from the manhole, said hoisting causing the perimeter of the disk to rise above the center of the disk and collapse, thereby trapping the fallen debris within the disk and removing the fallen debris from the manhole together with the disk.

In embodiments, the hoisting mechanism includes a telescoping pole. And in some embodiments the manhole includes an open conduit at its bottom, the debris removal device includes a plate removably attached to the bottom center of the flexible disk, said plate being configured to span the open conduit and support the disk at a level substantially even with a top of the open conduit, and lowering the debris removal device into the manhole includes lowering the debris removal device until the plate rests on a floor surrounding the open conduit and is substantially even with the top of the open conduit.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a top view illustrating the disk of the debris removal device, configured in accordance with an embodiment of the present invention wherein the unfolding mechanism includes four supports radiating outward from the center of the disk;

FIG. 2A is a side view illustrating the debris removal device with attached semi-rigid rods, configured in accordance with an embodiment of the present invention that includes a removable plate attached at its center and a peg descending downward from the plate and configured for resting in an open conduit so that the plate supports the center of the device;

FIG. 2B is a side view illustrating the debris removal device with attached semi-rigid rods, configured in accordance with an embodiment similar to FIG. 2A but including a larger high density polyethylene (“HDPE”) plate removably attached at its center and configured for spanning an open conduit so as to support the center of the device above the conduit;

FIG. 3A is side cutout view illustrating the debris removal device of FIG. 2A during insertion into a manhole having an open conduit across its center, configured according to an embodiment of the present invention;

FIG. 3B is side cutout view illustrating the debris removal device of FIG. 2B during insertion into a manhole having an open conduit across its center, configured according to an embodiment of the present invention;

FIG. 4 is a side cutout view illustrating the debris removal device of FIG. 3B fully inserted into a manhole with an open conduit across its center, and the insertion mechanism removed, configured according to an embodiment of the present invention; and

FIG. 5 is a side cutout view illustrating the debris removal device of FIG. 4 being removed from a manhole after performance of debris creating work.

### DETAILED DESCRIPTION

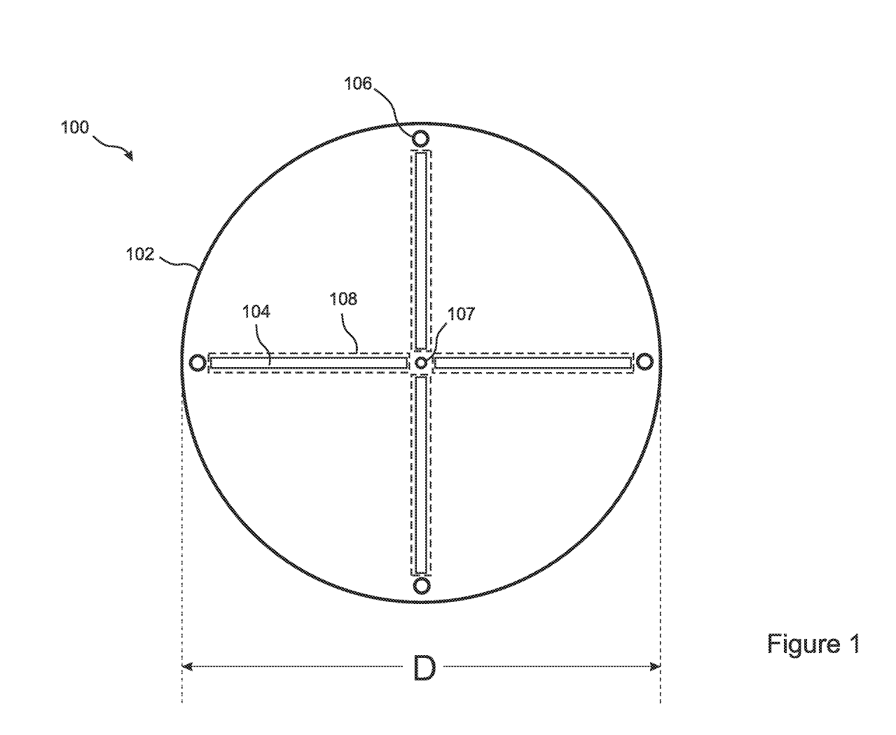

Referring to FIG. 1, the present invention is a debris removal device 100 that includes a flexible disk 102, typically made out of a fabric or canvas material. Equally spaced about the perimeter of the flexible disk 102 are eyelets 106, which can be used to suspend the disk 102 during lifting and lowering. Typically, at least four eyelets 106 are included. In the embodiment of FIG. 1, an eyelet 107 is also included in the center of the disk 102.

Also included in the apparatus 100 is an unfolding mechanism that will expand the perimeter of the disk 102, when the apparatus is resting on a surface, until the disk is flat, or until its perimeter is resting against the bounding wall of a manhole. In some embodiments, the unfolding mechanism includes supports 104, having proximal ends emanating radially from the center of the disk 102 and distal ends terminating proximally to the perimeter eyelets 106. In embodiments, the supports 104 are equal in number with the eyelets 106. In some embodiments, the supports 104 are flat rectangular metal straps, for example metal straps that are 1′8″ in length, ¾″ in width, and ⅛″ in thickness. In other embodiments, the supports 104 are made of high density polyethylene (“HDPE”) and are 1′6″ in length, 1″ in width, and ¼″ thick. The embodiment of FIG. 1 further includes an eyelet 107 at the center of the disk 102.

In various other embodiments the type and dimensions of the supports vary depending on the anticipated weight of the debris to be removed and the material used to make the supports 104. In embodiments, the supports are attached to the disk substantially along their entire lengths. In the embodiment of FIG. 1, the supports 104 are contained within pockets 108 that are stitched into the flexible disk 102. In similar embodiments, the supports are secured in numerous other ways known to one of ordinary skill in the art, such as by glue, or by loops of fabric, similar to belt loops, that extend over the supports and attach to the disk on either side of the supports 104. In the embodiment of FIG. 1, the diameter D of the disk 102 is about 4′, and is sized to fit within standard manholes.

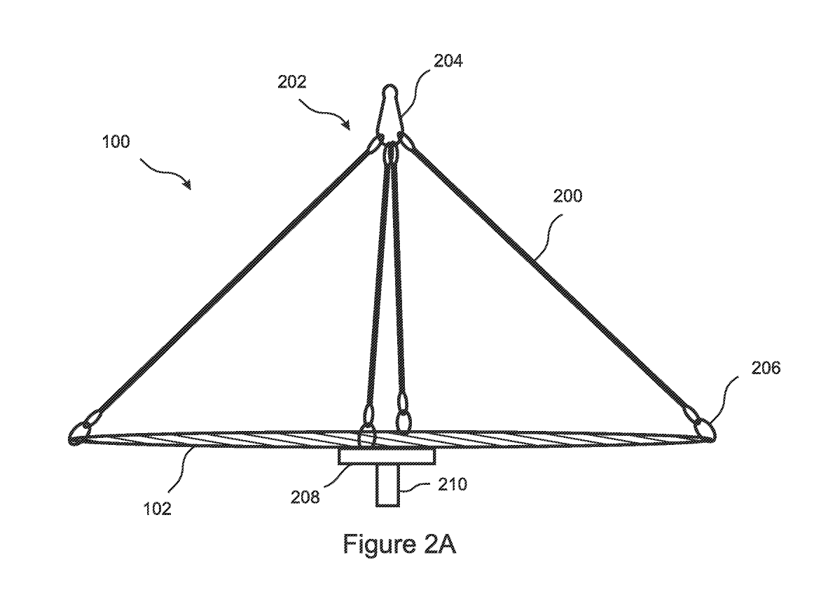

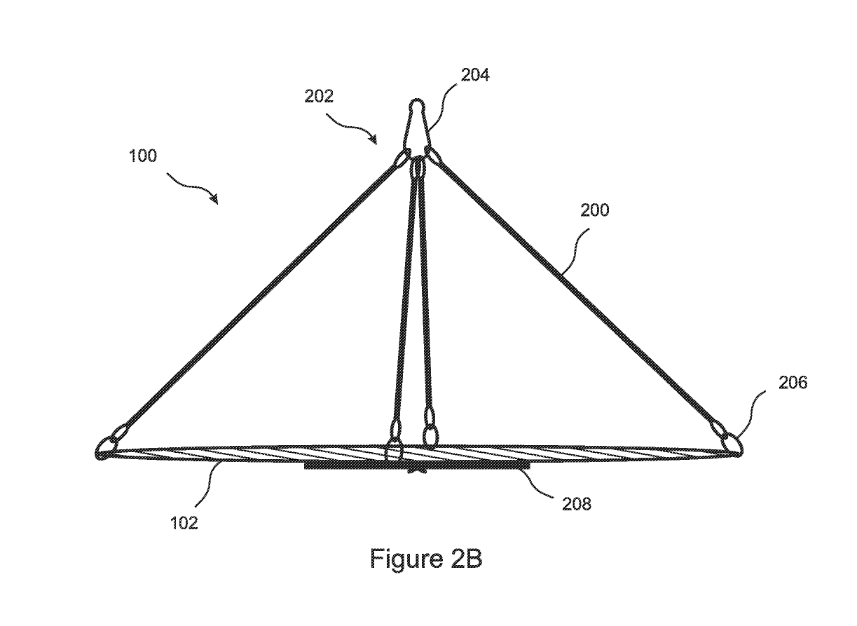

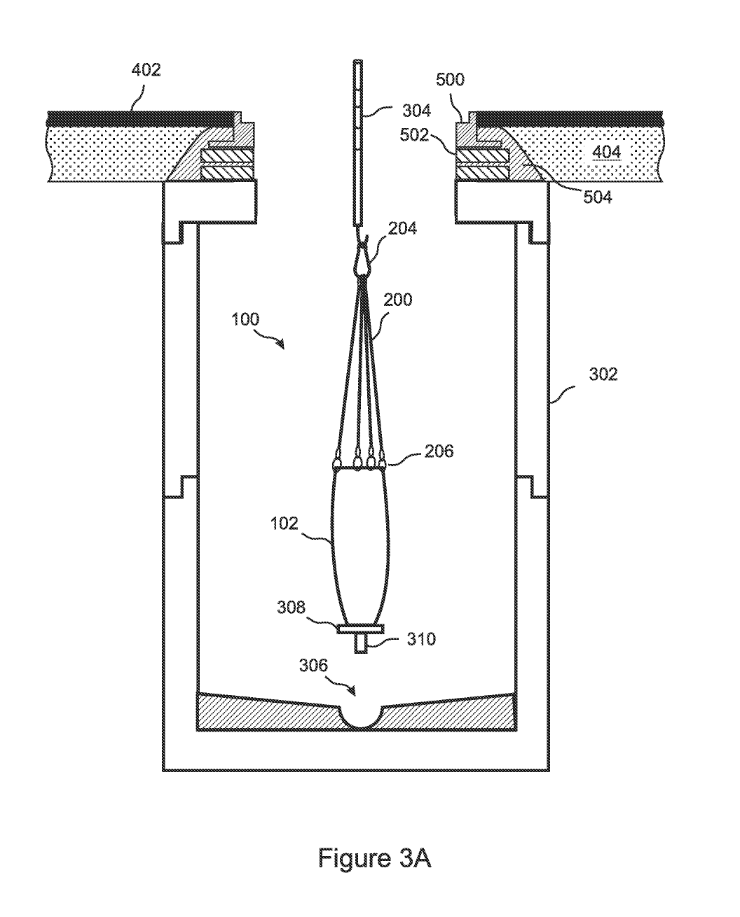

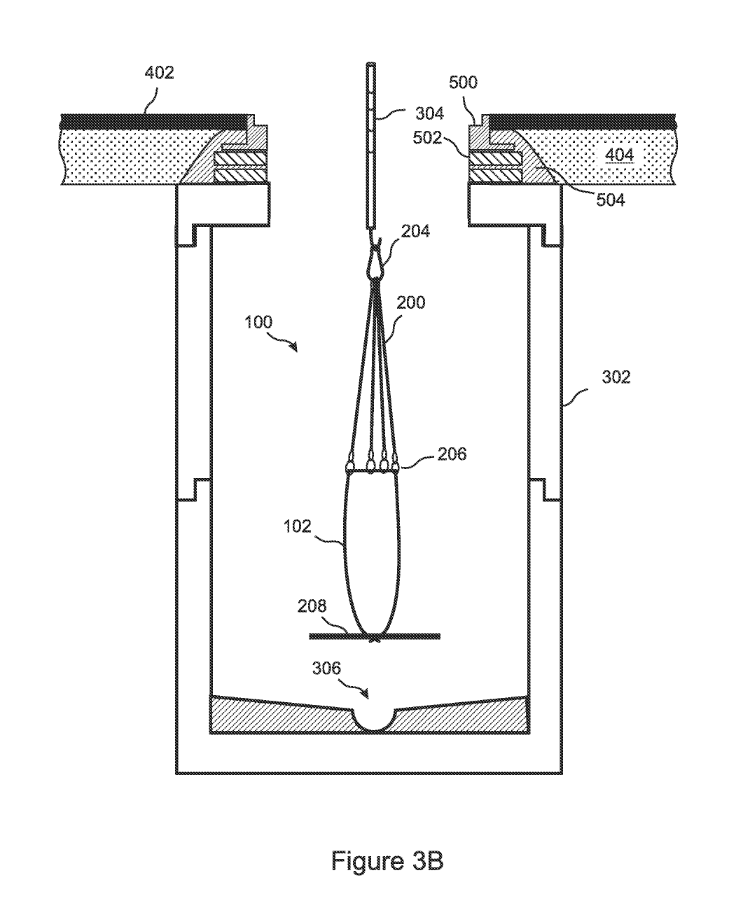

Referring to FIG. 2A, the debris removal device 100 includes semi-rigid rods 200 attached at their distal ends to the eyelets 106 and at their proximal ends to a common junction 202 above the disk. An attachment mechanism 204 is fixed to the common junction 202 for engagement with a hoisting or lifting mechanism. In the embodiment of FIG. 2A, the rods 200 are connected to the eyelets 106 by small clips 206. An attachment mechanism 204, which in FIG. 2A is a large clip 204, is connected to all rods 200 at their proximal ends for engagement with a hoisting or lifting mechanism, whereby the debris removal device 100 is inserted and removed from the manhole. The embodiment of FIG. 2A further includes a plate 208 fixed to the bottom center of the device 100 and a peg 210 secured to the bottom of the plate 208. The height of the peg 210 is approximately equal to the height of an open conduit 306 (see the discussion of FIG. 3A below), so that it can rest at the bottom of the open conduit 306 and support the plate 208 substantially at the level of the surrounding floor. The plate 208 can then support the center of the flexible disk 102, so that falling debris does not damage or puncture the center of the disk 102.

FIG. 2B is a side view of an embodiment similar to FIG. 2A, except that the plate 208 is larger than in FIG. 2A, and a peg 210 is not included. Instead, the plate 208 is configured to span the open conduit 306 and thereby support the center of the flexible disk 102, so that falling debris does not puncture the center of the disk 102. In embodiments, the plate 208 is removably attached to the disk 102, for example by inserting a 1¼″ long 5/16″ bolt through the plate 208 and through the central eyelet 107 in the flexible disk 102, and holding it in place with a 5/16″ lock washer and a 5/16″ wing nut. In some embodiments, the plate 208 is made of high density polyethylene (“HDPE”), and is ¼″ thick and 16″ in diameter.

Referring to FIG. 3A, the debris removal device 100 of FIG. 2A can be seen folded and in the process of being lowered into a manhole 302. In the embodiment of FIG. 3A, a telescoping retrieval device 304 with a hook on one end is used in conjunction with the attachment mechanism 204 for insertion of the debris removal device 100 into the manhole 302. In the figure, an open sewer conduit 306 is also visible at the bottom of the manhole 302.

FIG. 3B is a side view of the embodiment of FIG. 2B, shown with the debris removal device 100 of FIG. 2A folded and in the process of being lowered into the manhole 302.

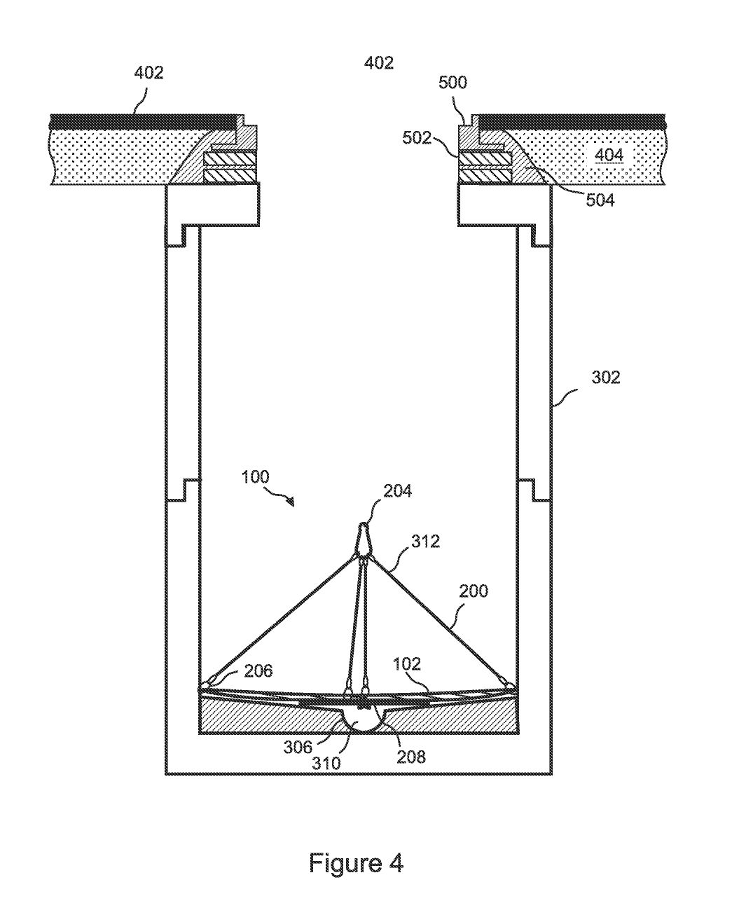

Referring to FIG. 4, the debris removal device 100 of FIG. 3B can be seen unfolded and resting on the bottom of the manhole 302, with the telescoping retrieval device 304 of FIG. 3 disengaged from the attachment mechanism 204. The support plate 208 is seen in the figure spanning the open conduit 310 and resting on the floor on either side of the conduit 310, thereby holding the center of the disk 102 approximately at the level of the surrounding floor.

After insertion of the debris removal device 100 into the manhole 302 and removal of the telescoping retrieval device 304, any required debris-generating work can be performed, such as removal of the pavement 402 and gravel 404 from around frame 500, re-working of the frame-supporting bricks 502 and mortar 504, adding new bricks 502 and mortar 504, and/or installing or reinstalling the frame 500.

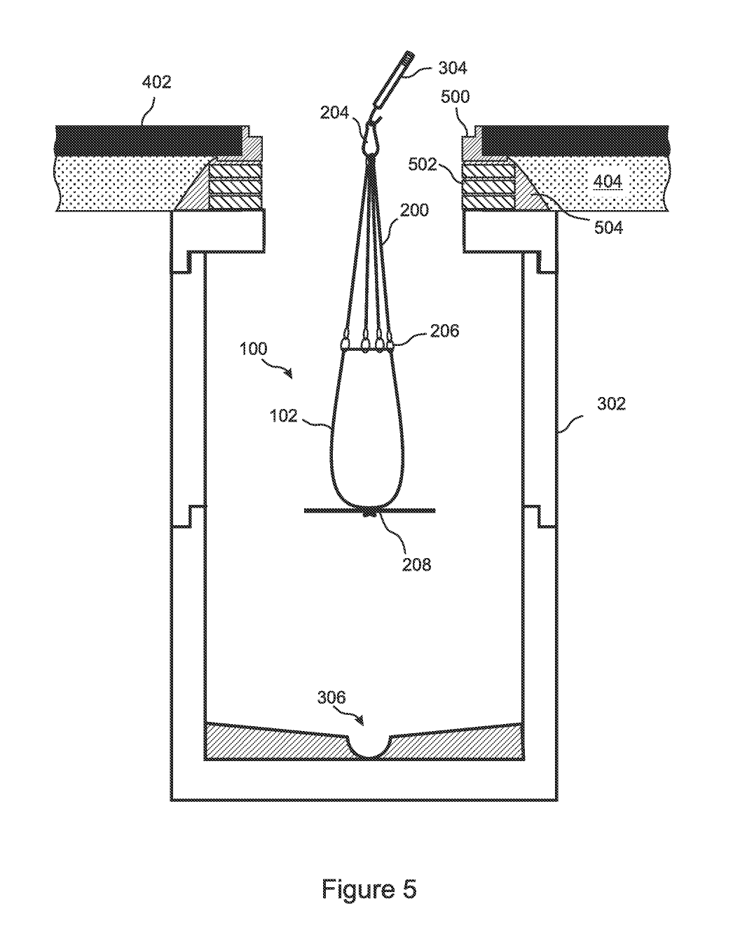

With reference to FIG. 5, once all debris-generating activity is completed, the telescoping retrieval device 304, or another hoisting mechanism, may be re-attached to the attachment mechanism 204, and the debris removal device 100 can be removed from the manhole 302. As the debris removal device 100 is lifted, the force of lifting by the attachment mechanism 204, which in FIG. 5 is a large clip 204, causes the perimeter of the disk 102 to rise above the center of the disk 102 and collapse, thereby trapping the debris and removing it together with the debris removal device 100. Once the debris removal device 100 is removed from the manhole 302, the debris can be properly and easily disposed of, without the use of expensive equipment or the need for personnel to enter the manhole.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A debris removal device for capturing and removing falling debris, the device comprising:
a flexible disk;
a plurality of eyelets adjacent to the perimeter of the flexible disk;
an unfolding mechanism, configured when the weight of the device is supported by a surface to unfold the flexible disk until the flexible disk is flat, or until the perimeter of the flexible disk is resting against a surrounding wall;
a plurality of substantially rigid rods having distal ends and proximal ends, the substantially rigid rods being equal in number with the eyelets, ii and being configured so that a distal end of a rod is pivotally secured to each eyelet;
a common junction above the flexible disk, at which the proximal ends of the rods pivotally terminate; and
an attachment mechanism fixed to the common junction, the attachment mechanism being configured for attachment thereto of a hoisting mechanism.

2. The debris removal device of claim 1, wherein the unfolding mechanism includes a plurality of substantially rigid supports radiating outwards from the center of the flexible disk, each of the supports being secured to the flexible disk over substantially its entire length.

3. The debris removal device of claim 2, wherein the supports are equal in number with the eyelets and are configured so that a distal end of a rigid support is proximal to each eyelet.

4. The debris removal device of claim 2, wherein the supports are secured to the flexible disk by stitching.

5. The debris removal device of claim 2, wherein the supports are semi-rigid metal straps.

6. The debris removal device of claim 2, wherein the supports are HDPE straps.

7. The debris removal device of claim 6, wherein the HDPE straps are approximately 1′6″ in length, approximately 1″ in width, and approximately ¼″ thick.

8. The debris removal device of claim 1, wherein the rods are approximately 3/16″ in diameter and approximately 2′9″ in length.

9. The debris removal device of claim 1, wherein the flexible disk is permeable to water.

10. The debris removal device of claim 1, wherein the flexible disk is constructed of a fabric material.

11. The debris removal device of claim 1, wherein the flexible disk is approximately four feet in diameter.

12. The debris removal device of claim 1, wherein each eyelet is reinforced by a metal grommet surrounding its perimeter.

13. The debris removal device of claim 1, wherein the attachment mechanism is a metal clip.

14. The debris removal device of claim 1, further comprising a hoisting mechanism, wherein the hoisting mechanism is a telescoping pole with a hook at its distal end of sufficient size to connect with the attachment mechanism.

15. The debris removal device of claim 1, further comprising:
a plate fixed to the bottom center of the flexible disk; and
a downwardly extending peg secured to a bottom of the plate, the peg being configured to rest at a bottom of an open conduit so as to position the plate substantially even with a top of the open conduit.

16. The debris removal device of claim 1, further comprising:
a plate fixed to the bottom center of the flexible disk, the plate being configured to span an open conduit so as to position the plate substantially even with a top of the open conduit.

17. The debris removal device of claim 16, wherein the plate is removably attached to the flexible disk.

18. A method for capturing and removing debris from a manhole after performing debris-creating work above the manhole, the method comprising:
providing a debris removal device including a flexible disk, a plurality of eyelets adjacent to the perimeter of the flexible disk, an unfolding mechanism configured to unfold the flexible disk when the weight of the device is supported by a surface until the flexible disk is flat, or until the perimeter of the flexible disk is resting against a surrounding wall, a plurality of substantially rigid rods having distal ends and proximal ends, the substantially rigid rods being equal in number with the eyelets, ii and being configured so that a distal end of a rod is pivotally secured to each eyelet, a common junction above the flexible disk, at which the proximal ends of the rods pivotally terminate, and an attachment mechanism fixed to the common junction, the attachment mechanism being configured for attachment thereto of a hoisting mechanism;
attaching a hoisting mechanism to the attachment mechanism;
lowering the debris removal device into the manhole, until the center of the flexible disk rests on the bottom of the manhole, and the unfolding mechanism unfolds the flexible disk until the flexible disk is flat or substantially all of its perimeter makes contact with the boundary wall of the manhole, while the semi-rigid rods extend upward above the flexible disk to the common junction;
detaching the hoisting device from the attachment mechanism and removing the hoisting device from the manhole;
performing the debris-creating work, whereby any debris that enters the manhole falls onto the flexible disk;
reattaching the hoisting mechanism to the attachment mechanism; and
hoisting the debris removal device out from the manhole, said hoisting causing the perimeter of the flexible disk to rise above the center of the flexible disk and collapse, thereby trapping the fallen debris within the flexible disk and removing the fallen debris from the manhole together with the flexible disk.

19. The method of claim 18, wherein the hoisting mechanism includes a telescoping pole.

20. The method of claim 18, wherein:
the manhole includes an open conduit at its bottom;
the debris removal device includes a plate removably attached to the bottom center of the flexible disk, said plate being configured to span the open conduit and support the flexible disk at a level substantially even with a top of the open conduit; and
lowering the debris removal device into the manhole includes lowering the debris removal device until the plate rests on a floor surrounding the open conduit and is substantially even with the top of the open conduit.
